(19) United States
(12) Patent Application Publication
(10) Pub. No.: US 2012/0154765 A1
(43) Pub. Date: Jun. 21, 2012

(54) VIDEO PROJECTOR

(75) Inventor: Yosuke Nishihata, Hirakata-shi (JP)

(73) Assignee: SANYO ELECTRIC CO., LTD., Osaka (JP)

(21) Appl. No.: 13/325,201

(22) Filed: Dec. 14, 2011

(30) Foreign Application Priority Data
Dec. 16, 2010 (JP) 2010-281032

(51) Int. Cl. G03B 21/14

(52) U.S. Cl. 353/88

(57) ABSTRACT

A video projector for projecting light of an image includes a shutter capable of blocking the light of an image. The shutter includes a plate member movable between a light blocking position, at which the plate member blocks the light of an image, and a non-blocking position, at which the plate member does not block the light of an image. An accommodation body accommodates the plate member. A drive mechanism moves the plate member. The plate member includes an irradiated portion that is irradiated with the light of an image when the plate member is located at the light blocking position. The irradiated portion includes a central part from which a projection projects in a thicknesswise direction of the plate member.

### CROSS-REFERENCE TO RELATED APPLICATIONS

This application is based upon and claims the benefit of priority from prior Japanese Patent Application No. 2010-281032, filed on Dec. 16, 2010, the entire contents of which are incorporated herein by reference.

### BACKGROUND OF THE INVENTION

The present invention relates to a video projector that includes a light shutter that is capable of blocking light of an image.

A video projector projects light onto a flat surface such as a screen to display an image. Japanese Laid-Open Patent Publication Nos. 2010-61052 and 2010-66419 each describe a video projector provided with a light shutter that blocks light emitted from a light source lamp.

The conventional light shield includes a door, or plate, that closes an opening of the video projector. The plate is arranged in a gap between a base and a cover, which hold the plate in a movable manner.

When the plate is irradiated with light, the temperature of the plate rises. The light of the light source lamp irradiates the plate with an uneven luminance distribution. Thermal expansion occurs in the plate. The thermal expansion is greater at a central portion that a peripheral portion in the plate. This thermally deforms and bends the entire plate.

Thermal deformation of the plate hinders smooth movement. For example, when the thermally expanded plate moves, the plate may be interfered with an accommodation body formed by the base and cover. For example, friction increases when the plate moves from a light blocking position, at which the plate blocks light, to a non-blocking position. Thus, a large force becomes necessary to move the plate to the non-blocking position. When the degree of thermal deformation is great, the plate cannot be moved to the non-blocking position.

When increasing the thickness of the plate to reduce thermal deformation of the plate, the weight of the plate increases. This increases the force required to move the plate. For example, a high-torque electric motor, which serves as a drive source, may become necessary. Alternatively, a large gear may become necessary to increase the gear ratio. Such structures would enlarge the light shutter and increase the manufacturing cost.

### SUMMARY OF THE INVENTION

One aspect of the present invention is a video projector for projecting light of an image. The video projector includes a shutter capable of blocking the light of an image. The shutter includes a plate member movable between a light blocking position, at which the plate member blocks the light of an image, and a non-blocking position, at which the plate member does not block the light of an image. An accommodation body accommodates the plate member. A drive mechanism moves the plate member. The plate member includes an irradiated portion that is irradiated with the light of an image when the plate member is located at the light blocking position. The irradiated portion includes a central part from which a projection projects in a thicknesswise direction of the plate member.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram showing a video projector according to one embodiment of the present invention;

FIGS. 2(a) and 2(b) are perspective views showing a light shutter;

FIG. 3 is a front view showing a plate of the light shutter of FIG. 2;

FIG. 4(a) is a side view showing the plate of FIG. 3, and FIG. 4(b) is an enlarged cross-sectional view taken along line A-A in FIG. 3;

FIG. 5 is a schematic cross-sectional view showing the light shutter of FIG. 2;

FIG. 6 is a schematic diagram showing a drive mechanism for the light shutter of FIG. 2;

FIGS. 7(a) and 7(b) are perspective views showing the plate when located at a non-blocking position;

FIG. 8(a) is a schematic cross-sectional view showing the light shutter of FIG. 7(a), and FIG. 8(b) is a partial enlarged view of FIG. 8(a);

FIG. 9(a) is a schematic cross-sectional view of the light shutter taken along line B-B in FIG. 7(a), and FIG. 9(a) is a schematic partially cross-sectional view showing the light shutter of FIG. 9(a); and

FIGS. 10 and 11 are front views showing modifications of the plate.

### DESCRIPTION OF THE INVENTION

One embodiment of the present invention will now be described with reference to the drawings. In the description hereafter, the XYZ orthogonal coordinate system will be used to describe relative positions. In the drawings, arrows Z indicate the upward and downward directions, which are not limited to the vertical direction. The arrows X indicate the frontward and rearward directions. The arrows Y indicate the leftward and rightward directions.

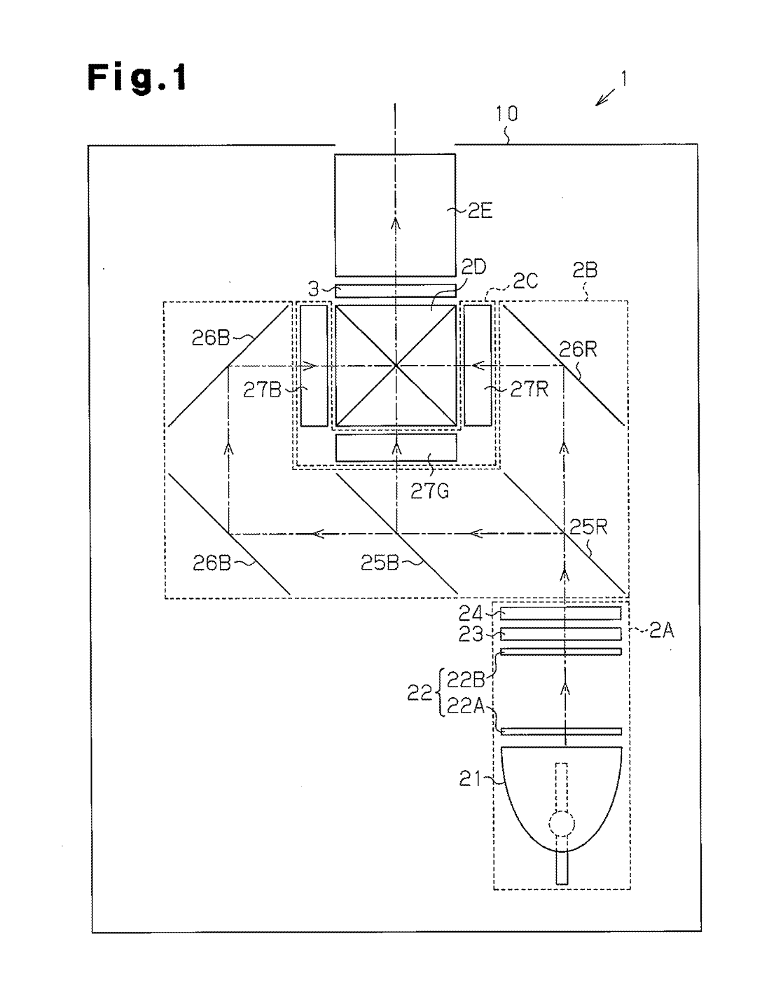

As shown in FIG. 1, a projector 1 includes a housing 10, which accommodates an optical system that displays an image. The optical system includes a light source unit 2A, which emits white light, a light separation unit 2B, which separates the three primary colors of light from the white light, an image generation unit 2C, which uses the three primary colors of light to generate an image, a light combining unit 2D, which combines the three primary colors of light, and a projection lens 2E, which projects the combined light.

The light source unit 2A includes a discharge lamp 21, which functions as a light source, an integrator lens 22, which evens the luminance of the white light emitted from the discharge lamp 21, a polarization converter 23, which lines polarization components of light, and a condensing lens 24, which condenses light. The light emitted from the discharge lamp 21 passes through the integrator lens 22, the polarization converter 23, and the condensing lens 24 and enters the light separation unit 2B. The integrator lens 22 is formed by two lens arrays 22A and 22B.

The light separation unit 2B includes a dichroic mirror 25R, which separates red light from light of other colors, a dichroic mirror 25B, which separates blue light from light of other colors, a full reflection mirror 26R, which guides the red light to a liquid crystal panel 27R, and a full reflection mirror 26B, which guides the blue light to a liquid crystal panel 27B. The dichroic mirrors 25R and 25B separate the white light emitted from the discharge lamp 21 of the light source unit 2A into red light, green light, and blue light. The separated red, green, and blue light respectively enter the liquid crystal panels 27R, 27G, and 27B.

The image generation unit 2C is formed by the liquid crystal panels 27R, 27G, and 27B. Each of the liquid crystal panels 27R, 27G, and 27B is a light valve capable of changing the transmittance of light for each pixel of an image. Red light passes through the liquid crystal panel 27R to generate red light of an image. Green light passes through the liquid crystal panel 27G to generate green light of an image. Blue light passes through the liquid crystal panel 27B to generate blue light of an image. The three colors of light respectively passing through the liquid crystal panels 27R, 27G, and 27B enter the light combining unit 2D.

The light combining unit 2D is formed by a cross dichroic prism. The light combining unit 2D combines the three colors of light, which enter the light combining unit 2D from different directions, and emits the light in a single direction. The image of the combined light enters the projection lens 2E.

The projection lens 2E, which is formed by a group of lenses, projects light of an image out of the projector 1. In this manner, the light of an image is emitted from the projector 1 and the image is displayed on a flat surface such as a screen or a wall.

As can be understood from the above description, the projector 1, which is a video projector, is a so-called three-chip LCD projector.

The projector 1 includes a light shutter 3, which is capable of blocking the light of an image so that the light is not projected out of the projector when the discharge lamp 21 is emitting light. The shutter 3 is arranged between the light combining unit 2D and the projection lens 2E.

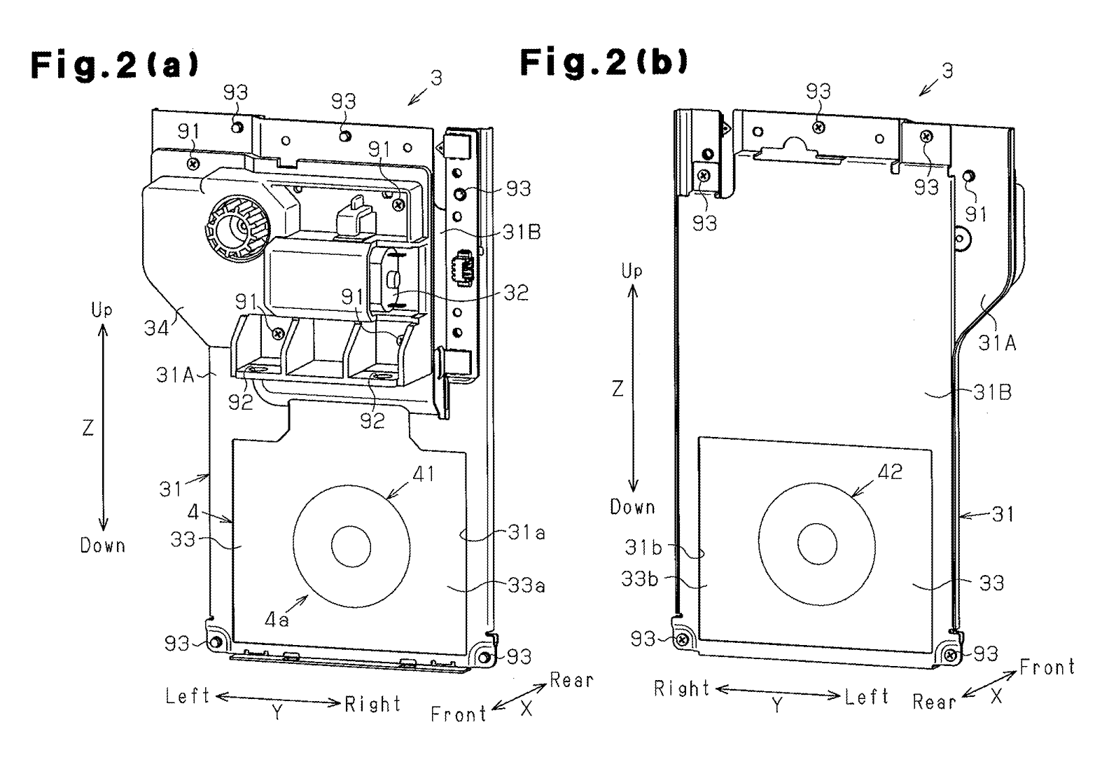

The shutter 3 will now be described with reference to FIGS. 2 to 9.

As shown in FIG. 2(a), the shutter 3 includes a first base material 31A, which is formed by a metal plate, an electric motor 32, which is attached to a front surface of the first base material 31A, a plate 33, which is driven and moved by the electric motor 32, and a cover 34, which covers the electric motor 32.

A tetragonal opening 31a is formed in a lower portion of the first base material 31A. The shutter 3 is positioned so that the light of an image emitted from the light combining unit 2D passes through the opening 31a.

The electric motor 32 is supplied with power from a motor drive power supply unit (not shown) and generates power for moving the plate 33. Wiring connecting the electric motor 32 and the motor drive power supply unit (not shown) is not illustrated in the drawings.

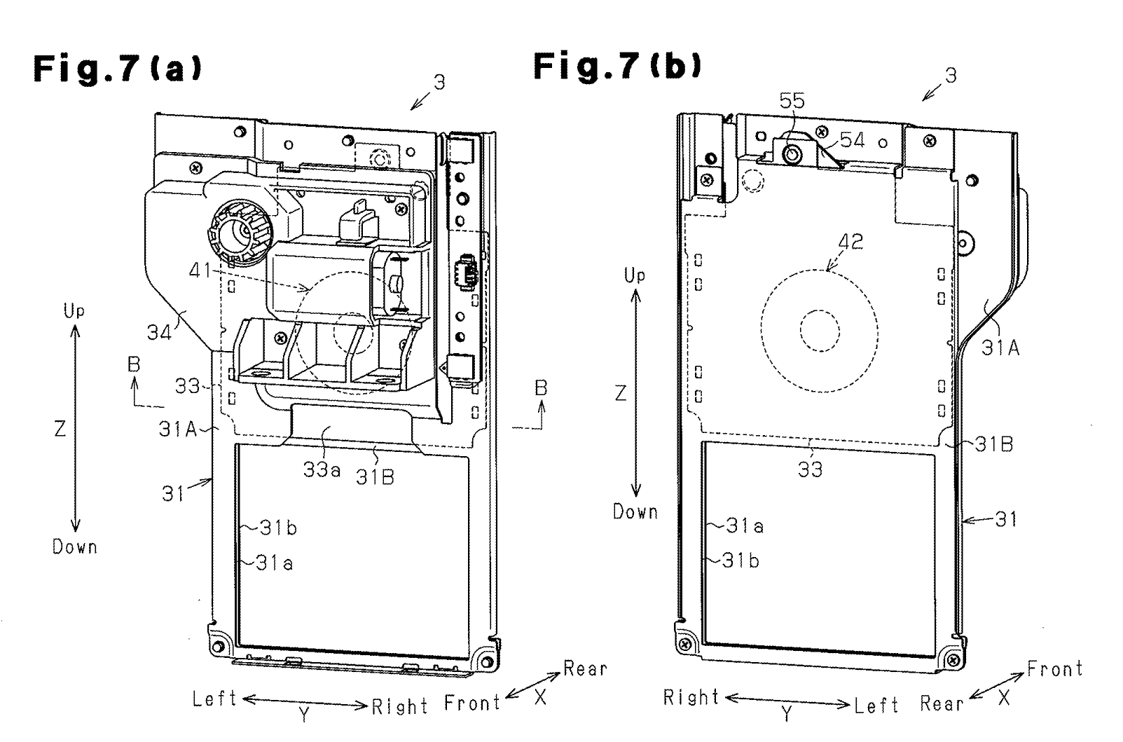

The plate 33 is moveable in upward and downward directions and formed from a metal plate of stainless steel or the like. The plate 33 is arranged rearward from the first base material 31A. The plate 33 is movable between a light blocking position (FIG. 2) and a non-blocking position (FIG. 7). When the plate 33 is located at the light blocking position, the light of an image is not projected out of the projector 1. When the plate 33 is located at the non-projecting position, the light of an image is projected out of the projector 1.

The cover 34 is a molded product formed from a resin material. Screws 91 are used to fix the cover 34 to the first base material 31A. Through holes 92 extend through the cover 34 in the upward and downward directions. Screws (not shown) are inserted through the through holes 92 to fasten an internal structure (not shown) of the projector 1 to the shutter 3.

As shown in FIG. 2(b), the shutter 3 includes a second base material 31B, which is formed from a metal plate. The second base material 31B is arranged rearward from the plate 33. The plate 33 is arranged between the first base material 31A and the second base material 31B. The first base material 31A and second base material 31B form an accommodation body 31, which accommodates the plate 33.

A tetragonal opening 31b is formed in a lower portion of the second base material 31B. The second base material 31B is fixed to the first base material 31A by screws 93 so that the opening 31b overlaps with the opening 31a of the first base material 31A.

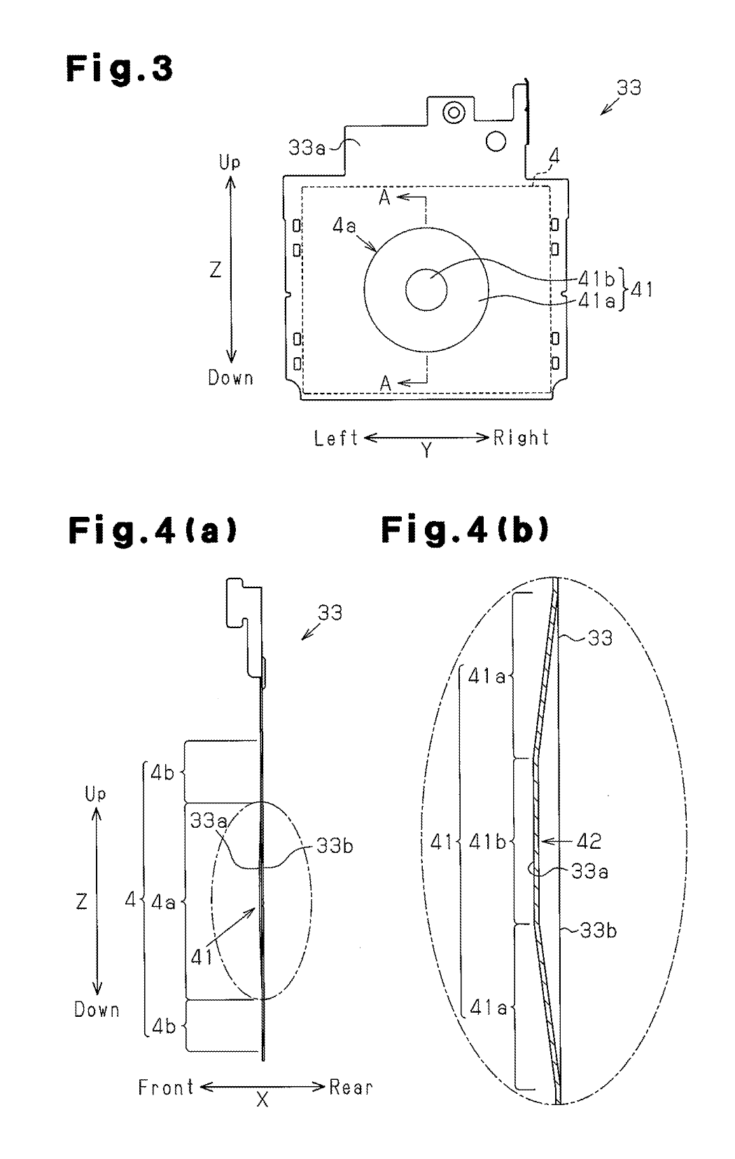

The structure of the plate 33 will now be described with reference to FIGS. 3 and 4.

As shown in FIG. 3, the plate 33 includes an irradiated portion 4. The irradiated portion 4 is formed at a position irradiated by the light of an image emitted from the light combining unit 2D when the plate 33 is located at the light blocking position. In other words, the irradiated portion 4 is defined by the portion of the plate 33 corresponding to the opening 31a. In the illustrated example, the irradiated portion 4 is tetragonal.

As shown in FIGS. 3 and 4(a), the irradiated portion 4 includes a central part 4a and a peripheral part 4b. The central part 4a includes a projection 41, which projects in the thicknesswise direction of the plate 33. A pressing process or drawing process is performed to form the projection 41. In the present embodiment, the projection 41 projects toward the front. It is preferable that the peripheral part 4b, which is the part of the irradiated portion 4 excluding the projection 41, be flat.

The projection 41 extends in the radial direction about a point in the central part 4a of the plate 33. The projection 41 is circular when viewed in the thicknesswise direction of the plate 33. In the illustrated example, the projection 41 has the shape of a truncated cone and includes a sloped surface 41a, which forms the side surface of the truncated cone, and a round and flat peak surface 41b, which is surrounded by the sloped surface 41a. The sloped surface 41a is inclined relative to the peak surface 41b and the peripheral part 4b of the irradiated portion 4. Further, the peak surface 41b is parallel to the peripheral part 4b of the irradiated portion 4.

As shown in FIGS. 4(a) and 4(b), the plate 33 includes a projection side surface 33a, which faces the projection direction of the projection 41 (i.e., forward direction), and an opposite non-projection side surface 33b. The projection 41 forms part of the projection side surface 33a. Accordingly, the projection side surface 33a is bulged further toward the front at the central part 4a of the irradiated portion 4 than at the peripheral part 4b of the irradiated portion 4.

In a state in which the plate 33 is located at the light blocking position, the light combining unit 2D is arranged toward the front of the plate 33, and the projection lens 2E is arranged toward the rear of the plate 33. The projection side surface 33a, which serves as a front surface of the plate 33, faces the cross dichroic prism of the light combining unit 2D. The non-projection side surface 33b, which serves as a rear surface of the plate 33, faces the projection lens 2E. Accordingly, the projection 41 projects away from the projection lens 2E.

The plate 33 includes a generally even thickness. As shown in FIG. 4(b), the plate 33 includes a depression 42, which corresponds to the projection 41. The depression 42 forms part of the non-projection side surface 33b. The non-projection side surface 33b at the central part 4a of the irradiated portion 4 is offset further toward the front than the non-projection side surface 33b at the peripheral part 4b of the irradiated portion 4.

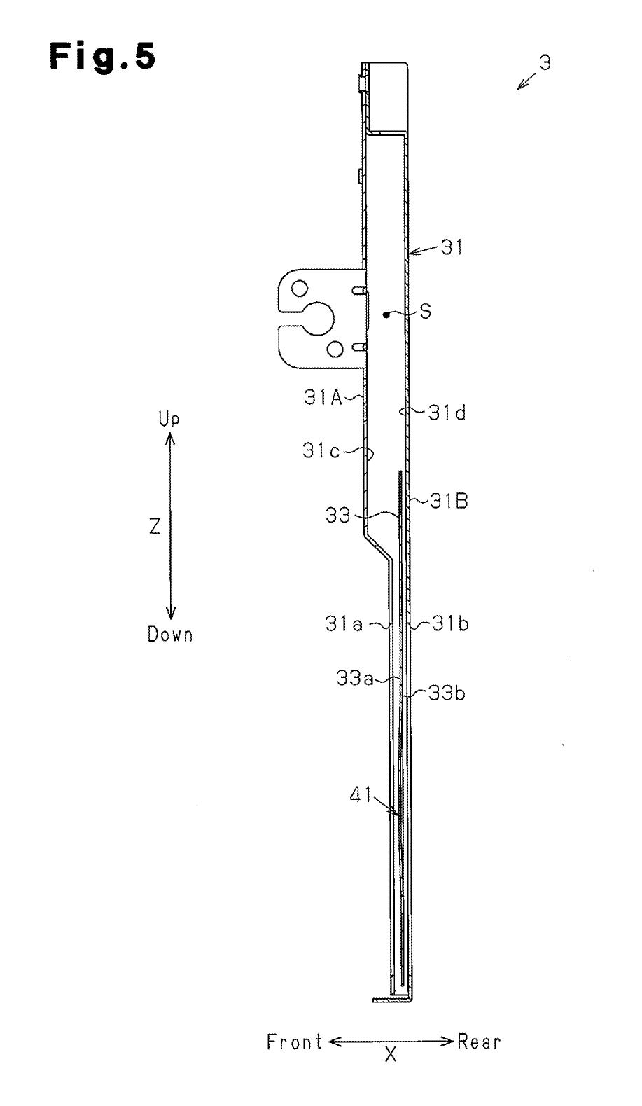

The structure of the accommodation body 31 will now be described with reference to FIG. 5, which shows only the first base material 31A, the second base material 31B, and the plate 33.

As shown in FIG. 5, an accommodation space S, which accommodates the plate 33 when located at the non-blocking position, is defined between the upper portion of the first base material 31A and the upper portion of the second base material 31B. The plate 33 is moved upward to be accommodated in the accommodation space S. The accommodation body 31 includes a projection side inner surface 31c, which faces the projection side surface of the plate 33, and a non-projection side inner surface 31d, which faces the non-projection side surface 33b. When the plate 33 is moved to the non-blocking position from the light blocking position, the projection 41 faces the projection side inner surface 31c. The projection side inner surface 31c of the accommodation body 31 is formed by part of the rear surface of the first base material 31A. The non-projection side inner surface 31d of the accommodation body 31 is formed by the front surface of the second base material 31B.

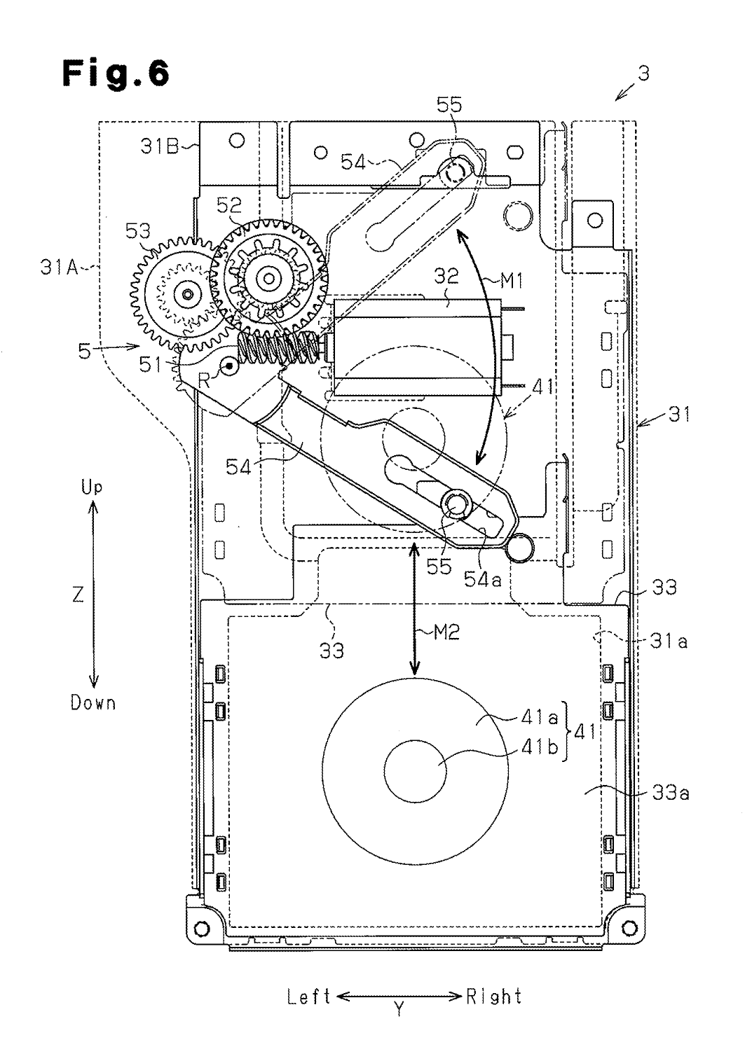

A drive mechanism 5 will now be described with reference to FIG. 6.

The drive mechanism 5 includes a transmission connected to the electric motor 32 and plate 33. The transmission includes a worm 51, which is arranged on the electric motor 32, a worm wheel 52, which is engaged with the worm 51, a gear 53, which is engaged with the worm wheel 52, and an arm 54, which is engaged with the gear 53.

Rotation of the worm 51 rotates the worm wheel 52. Rotation of the worm wheel 52, which is a two-stage gear, rotates the gear 53. Rotation of the gear 53, which is also a two-stage gear 53, pivots the elongated arm 54 about a pivot shaft R in the directions indicated by arrows M1 in FIG. 6.

A rod 55 is fixed to the plate 33. The arm 54 includes a rod support hole 54a and supports the rod 55 in a pivotal manner with the rod support hole 54a. The rod support hole 54a is an elongated hole extending in the longitudinal direction of the arm 54. When the arm 54 pivots, the plate 33 moves linearly as shown by the arrows M2 in FIG. 6. The plate moves upward or downward in accordance with the direction of the rotation produced by the electric motor 32.

In this manner, the transmission transmits the power generated by the electric motor 32 to the plate 33. This moves the plate 33 to the light blocking position and the non-blocking position, in which the plate 33 is accommodated in the accommodation space S.

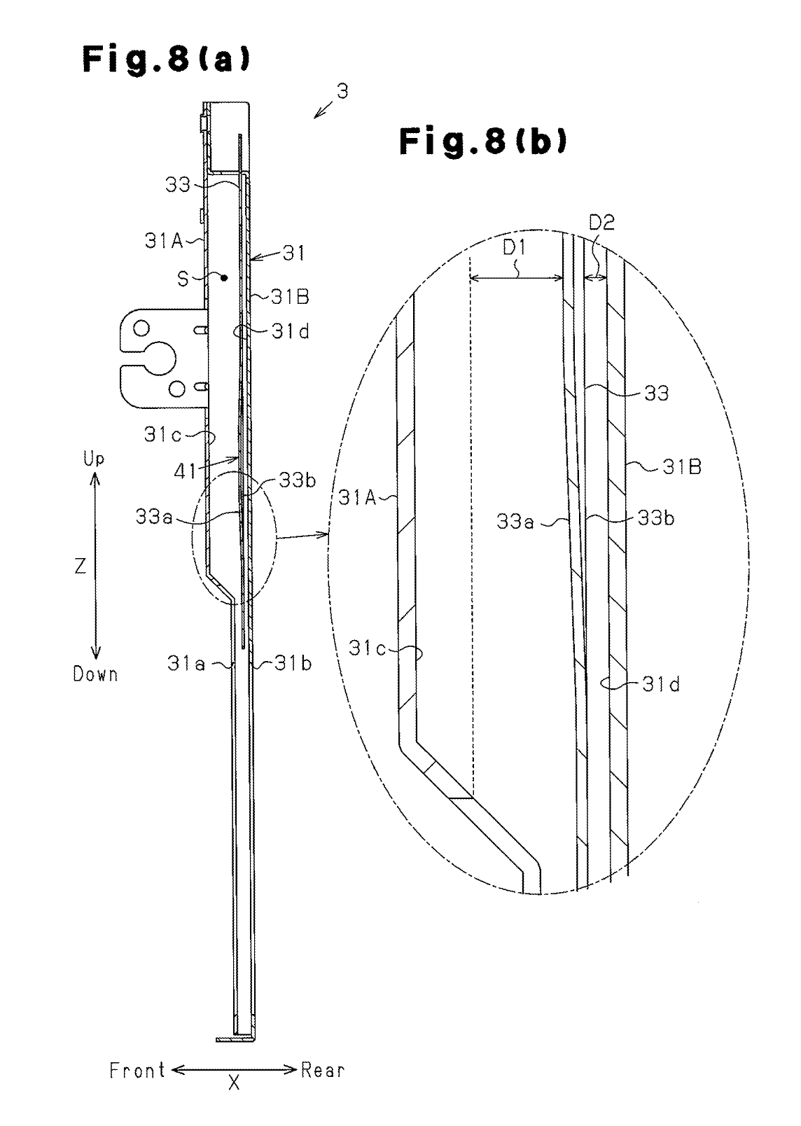

As shown in FIG. 8(a), when the plate 33 is accommodated in the accommodation space S, a lower end of the plate 33 is located upward from the opening 31b. FIG. 8(b) shows distance D1, which is the shortest distance between the projection side surface 33a of the plate 33, and the projection side inner surface 31c of the accommodation body 31. FIG. 8(b) also shows distance D2, which is the shortest distance between the non-projection side surface 33b of the plate 33, and the projection side inner surface 31c of the accommodation body 31. The dimensions of the plate 33 and the accommodation space S of the accommodation body 31 are set so that distance D1 is greater than distance D2. In the illustrated example, the shortest distance D1 is the distance between the lower end of the projection side inner surface 31c, which faces the movement path of the projection 41 on the plate 33, and the peak surface 41b of the projection 41.

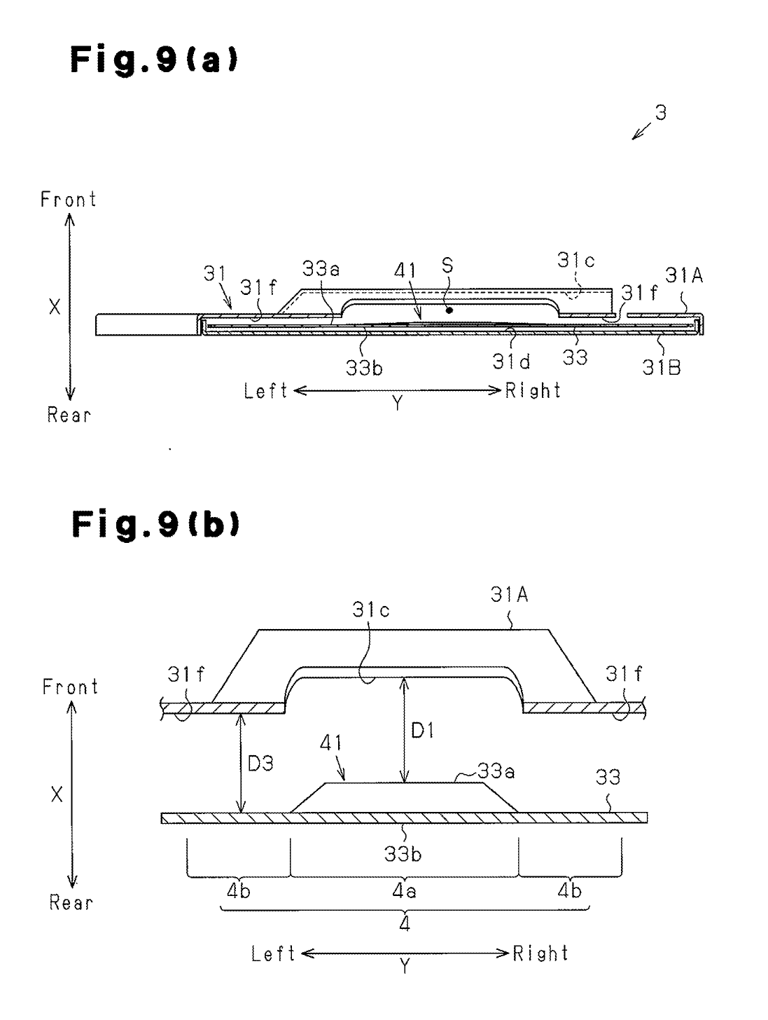

As shown in FIG. 9(a), the accommodation body 31 includes a peripheral inner surface 31f, which faces toward the peripheral part 4b of the projection side surface 33a that excludes the projection 41 when the plate 33 is moved to the non-blocking position. That is, the peripheral inner surface 31f does not face the projection 41 and faces the projection side surface 33a. The peripheral inner surface 31f is defined by a portion of the rear surface of the first base material 31A excluding the projection side inner surface 31c. Distance D3 between the projection side surface 33a of the plate 33 and the peripheral inner surface 31f is smaller than the shortest distance D1 between the projection side surface 33a of the plate 33 and the projection side inner surface 31c.

The operation of the present invention will now be described.

When the projector 1 displays an image, the plate 33 is shifted to the non-blocking position shown in FIG. 7. When the projector 1 interrupts the display of an image while maintaining a state in which the discharge lamp 21 is emitting light, the plate 33 is moved from the non-blocking position to the light blocking position. Here, the plate 33 blocks light, and the light of an image is thus not projected from the projection lens 2E. In this state, the irradiated portion 4 of the plate 33 is continuously irradiated with light. Thus, the plate 33 may be deformed due to thermal expansion. The projection 41 controls the deformation of the plate 33 so that the projection bulges only in the frontward direction, which conforms to the projection direction of the projection 41. When a flat plate that does not include a projection is irradiated with light, the direction in which the plate bulges is indefinite. When the projector 1 commences the display of an image again, the plate 33 moves from the light blocking position to the non-blocking position.

The advantages of the present embodiment will now be described.

(1) The plate 33 is movable to the light blocking position, which blocks the light of an image, and the non-blocking position, which does not block the light of an image. The plate 33 includes the irradiated portion 4, which is irradiated with the light of an image when the plate 33 is located at the light blocking position. The central part 4a of the irradiated portion 4 includes the projection 41, which projects in the thicknesswise direction of the plate 33. This increases the bending rigidity of the plate 33 and suppresses thermal deformation of the plate 33. When the irradiated portion 4, which includes the projection 41, is irradiated with light, the irradiated portion 4 is deformed bulging in the projection direction of the projection 41. That is, the projection 41 controls thermal deformation so that the plate 33 bulges only in a certain direction. Even though the distance (e.g., D2) between the plate 33 and the accommodation body 31 is small in a direction (i.e., rearward direction) opposite to the projection direction, as long as the distance (e.g., D1) between the plate 33 and the accommodation body 31 in the projection direction (i.e., frontward direction) of the projection 41 is ensured, the plate 33 is not interfered by the accommodation body 31 when the thermally deformed plate 33 moves to the non-blocking position. In this manner, thermal deformation of the plate 33 is suppressed and interference of the plate 33 with the accommodation body 31 is prevented without increasing the thickness of the plate 33. Even when the plate 33 moves to the non-blocking position after the plate 33 continuously blocks the light of an image at the light blocking position, friction between the plate 33 and the accommodation body 31 is prevented from increasing.

(2) The projection 41 extends in the radial direction about a point in the central part 4a of the plate 33. When the irradiated portion 4 of the plate 33 is irradiated with the light emitted from the discharge lamp 21, which is a typical light source, the luminance of light decreases from the central part 4a to the peripheral part 4b in the irradiated portion 4. Thus, the plate 33, when thermally deformed, is controlled to bulge only in a certain direction.

(3) The projection 41 is circular when viewing the plate 33 in a thicknesswise direction, or from the front. More specifically, when viewing the plate 33 in a thicknesswise direction, or from the front, the projection 41 extends in the radial direction about a point in the central part 4a of the plate 33. Thus, the plate 33, when thermally deformed, is controlled to bulge only in a certain direction.

(4) The plate 33 faces the projection lens 2E. The projection 41 projects away from the projection lens 2E. Thus, even when the projection lens 2E is a convex lens facing the plate 33, the plate 33 does not come into contact with the projection lens 2E.

(5) The shortest distance D1 between the projection side surface 33a and the projection side inner surface 31c is greater than the shortest distance D2 between the non-projection side surface 33b and the non-projection side inner surface 31d. Since the shortest distance D1 between the projection side surface 33a of the plate 33 and the projection side inner surface 31c of the accommodation body 31 is large, the thermally deformed plate 33 is easily prevented from being interfered by the accommodation body 31. Further, since the shortest distance D2 between the non-projection side surface 33b of the plate 33 and the non-projection side inner surface 31d of the accommodation body 31 is small, the accommodation body 31 can be reduced in size. Accordingly, the plate 33 is prevented from being interfered by the accommodation body 31, and the shutter 3 can be reduced in size.

(6) The peripheral inner surface 31f is arranged closer to the projection side surface 33a than the projection side inner surface 31c. Thus, in comparison with when forming the peripheral inner surface 31f and the projection side inner surface 31c with a single flat surface, the distance between the projection side surface 33a of the plate 33 and the peripheral inner surface 31f may be decreased while preventing the plate 33 from being interfered by the accommodation body 31. Further, the accommodation body 31 can be reduced in size.

It should be apparent to those skilled in the art that the present invention may be embodied in many other specific forms without departing from the spirit or scope of the invention. Particularly, it should be understood that the present invention may be embodied in the following forms.

The shutter 3 does not have to include the electric motor 32. More specifically, any structure can be used for the plate 33 to be movable. For example, a structure that manually moves the plate 33 to the light blocking position and non-blocking position may be used.

The projection 41 does not have to be projected toward the projection lens 2E. The projection arranged on the central part 4a of the irradiated portion 4 may project in either one of the frontward and rearward directions.

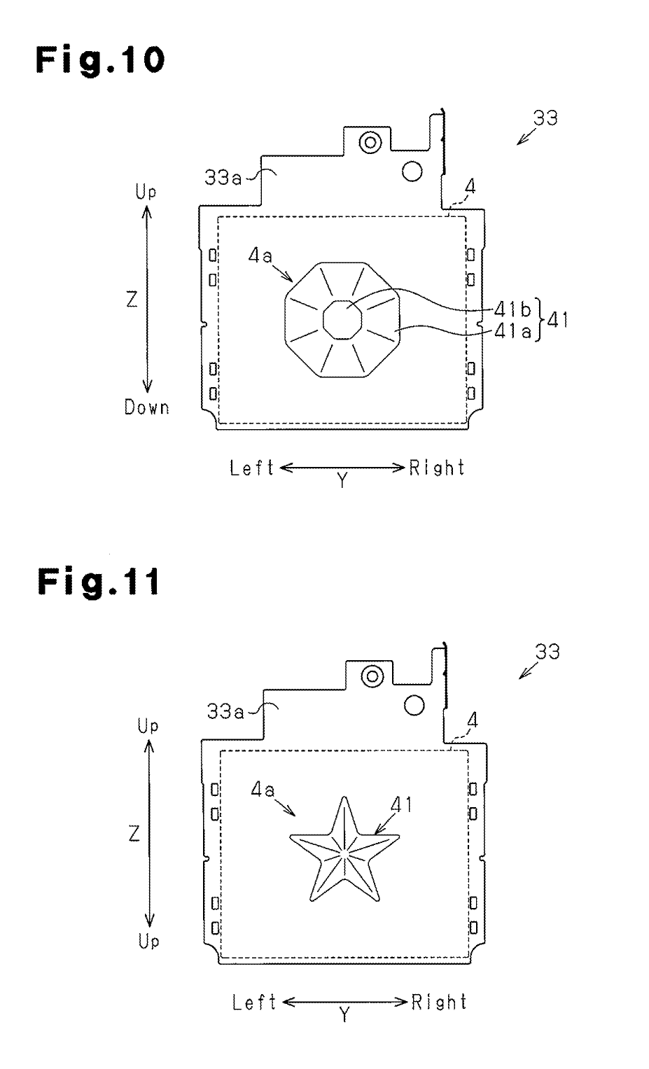

The projection 41 does not have to be circular when viewed from the thicknesswise direction of the plate 33. For example, as shown in FIG. 10, the projection 41 may be polygonal, for example, octagonal. Further, as shown in FIG. 11, the projection 41 does not have to include the flat peak surface 41b.

The projection 41 does not have to extend in the radial direction about a point in the central part 4a of the plate 33. As long as the projection 41 projects in the thicknesswise direction of the plate 33, the projection 41 may have any shape.

The shutter 3 does not have to be arranged between the light combining unit 2D and the projection lens 2E. For example, the shutter 3 may be arranged in the path of light from the discharge lamp 21 to the light combining unit 2D. Alternatively, the shutter 3 may be arranged in the path of light at the exit side of the projection lens 2E. In other words, the location of the shutter 3 may be changed as long as the light emitted from the discharge lamp 21, which serves as a light source, can be blocked. However, plural paths of light are present between the light separation unit 2B, which separates light, and the light combining unit 2D, which combines the light. Thus, it is preferable that the shutter 3 be arranged in the path of light between the light combining unit 2D and the projection lens 2E or in the path of light between the discharge lamp 21 and the dichroic mirror 25R.

The video projector is not limited to the projector 1, which generates an image by passing light through liquid crystal panels. For example, the video projector may be a projector that generates an image by using a digital micromirror device (DMD) that selectively reflects light.

The present examples and embodiments are to be considered as illustrative and not restrictive, and the invention is not to be limited to the details given herein, but may be modified within the scope and equivalence of the appended claims.

1. A video projector for projecting light of an image, the video projector comprising a shutter capable of blocking the light of an image, wherein the shutter includes:
a plate member movable between a light blocking position, at which the plate member blocks the light of an image, and a non-blocking position, at which the plate member does not block the light of an image;
an accommodation body that accommodates the plate member; and
a drive mechanism that moves the plate member, wherein
the plate member includes an irradiated portion that is irradiated with the light of an image when the plate member is located at the light blocking position, and
the irradiated portion includes a central part from which a projection projects in a thicknesswise direction of the plate member.

2. The video projector according to claim 1, wherein the projection extends in a radial direction about a point in the central part of the plate member.

3. The video projector according to claim 2, wherein the projection is circular when viewed from the thicknesswise direction of the plate member.

4. The video projector according to claim 1, further comprising a projection lens that projects the light of an image, wherein
the plate member and the projection lens face each other, and
the projection projects away from the projection lens.

5. The video projector according to claim 1, wherein
the plate member includes a projection side surface, which faces a projection direction of the projection, and an opposite non-projection side surface,
the accommodation body includes a projection side inner surface, which faces the projection side surface when the plate member moves to the non-blocking position, and a non-projection side inner surface, which faces the non-projection side surface, and
the shortest distance between the projection side surface and the projection side inner surface is greater than the shortest distance between the non-projection side surface and the non-projection side inner surface.

6. The video projector according to claim 1, wherein
the plate member includes a projection side surface that faces a projection direction of the projection,
the accommodation body includes a projection side inner surface, which faces the projection on the projection side surface when the plate member moves to the non-blocking position, and a peripheral inner surface, which faces toward a portion of the projection side surface excluding the projection when the plate member moves to the non-blocking position, and
the peripheral inner surface is arranged closer to the projection side surface than the projection side inner surface.

7. The video projector according to claim 1, wherein
the irradiated portion of the plate member excluding the projection defines a flat peripheral part,
the projection is positioned relative to the light of an image so that when the plate member is located at the light blocking position, the flat peripheral part of the irradiated portion is irradiated by the light of an image with a relatively low luminance, and the projection is irradiated by the light of an image with a relatively high luminance.

8. The video projector according to claim 7, wherein the accommodation body includes
a projection side inner surface that faces a movement path of the projection when the plate member moves from the light blocking position to the non-blocking position, and
a non-projection side inner surface, which is opposite to the projection side inner surface,
the shortest distance between the projection and the projection side inner surface is greater than the shortest distance between the flat peripheral part and the non-projection side inner surface.

9. The video projector according to claim 8, wherein the plate member is formed from a single metal plate.
